(19) United States
(12) Patent Application Publication
(10) Pub. No.: US 2023/0014650 A1
(43) Pub. Date: Jan. 19, 2023

(54) MOTOR FOR VEHICLE, STEERING FEEDBACK ACTUATOR APPARATUS AND STEERING APPARATUS WITH THE SAME

(71) Applicant: MANDO CORPORATION, Gyeonggi-do (KR)

(72) Inventor: Tae Sik KIM, Gyeonggi-do (KR)

(21) Appl. No.: 17/858,063

(22) Filed: Jul. 5, 2022

(30) Foreign Application Priority Data
Jul. 7, 2021 (KR) 10-2021-0089116

(51) Int. Cl. B62D 5/00; H02K 16/00; H02K 7/00; H02K 5/04; H02K 1/24; H02K 1/16

(52) U.S. Cl. CPC B62D 5/006; H02K 16/00; H02K 7/003; H02K 5/04; H02K 1/24; H02K 1/16

(57) ABSTRACT

The present disclosure relates to a motor for a vehicle and a steering feedback actuator apparatus and a steering apparatus including the motor for a vehicle. The motor for a vehicle according to this embodiment may include: a motor housing; a motor shaft coupled with the motor housing to relatively rotate with respect to the motor housing; a dual rotor including an inner rotor and an outer rotor connected to the motor shaft; and a dual stator including an inner stator arranged on an inner side of the inner rotor and an outer stator arranged on an outer side of the outer rotor.

### CROSS-REFERENCE TO RELATED APPLICATION

This application claims priority from Korean Patent Application No. 10-2021-0089116, filed on Jul. 7, 2021, which is hereby incorporated by reference for all purposes as if fully set forth herein.

### BACKGROUND OF THE INVENTION

### Field of the Invention

The present disclosure relates to a motor for a vehicle, a steering feedback actuator apparatus and a steering apparatus with the same. In more detail, the present disclosure relates to a motor for a vehicle including dual rotors disposed inside and outside and dual stators disposed inside and outside, a steer-by-wire steering apparatus including the motor, and the like.

### Description of Related Art

Many electric motors are used in a steering apparatus, a braking apparatus, a power system, and the like of a vehicle.

Particularly, electric vehicles, hydrogen-fueled vehicles, and the like have been actively developed recently, and thus the need for using motors inside vehicles has increased further.

As one of vehicle apparatuses in which motors are used, a steering apparatus as an apparatus for controlling a traveling direction of a vehicle is used, and, recently, electric power steering (hereinafter referred to as “EPS”) apparatuses in which a steering motor provides a steering force required for controlling a traveling direction of a vehicle through electronic control are widely used.

Such an EPS steering apparatus drives an EPS steering motor in accordance with a steering torque applied to a steering wheel by a driver and operates to rotate a steering column or move a rack bar connected thereto.

For this, an EPS steering apparatus includes an EPS steering motor and a steering electronic control unit (ECU) controlling the steering motor, a reducer used for obtaining a high rotation output by reducing an output rotation number at a predetermined ratio is connected to the steering motor, and the reducer operates with being interlocked with a steering column or a rack bar. An example of a steering system includes a steering apparatus of a Steer-By-Wire (SBW) system in which steering wheel-side devices and drive-side devices are mechanically separated from each other.

Such an SBW steering apparatus includes a steering wheel-side assembly and a drive-side assembly, and the steering wheel-side assembly and the drive-side assembly are mechanically separated from each other.

In addition to a steering wheel and a steering column, the steering wheel-side assembly may include a Steering Feedback Actuator (SFA) for providing a steering feeling (a vibration or the like) according to steering for the steering wheel.

Such a steering feedback actuator includes a feedback motor, a reducer, and the like, and in order to provide an accurate steering feeling, a low cogging torque and an output of a predetermined level or higher need to be secured. In order to secure a low cogging torque and an output of a predetermined level or higher, a general steering feedback actuator of the SBW type uses a reducer of a pulley-belt type or a worm-shaft/worm-gear type in addition to the feedback motor.

Thus, in accordance with use of a reducer of the pulley-belt type or the worm-axis/worm-gear type, there are problems in that the structure of the steering feedback actuator becomes complicated, a layout is difficult to design, and the like.

In addition, also in the case of various motors used in vehicles, like a motor for the steering feedback actuator described above, an output of a predetermined level or higher needs to be implemented while minimizing a cogging torque.

The present disclosure proposes a motor for a vehicle that has a low cogging torque and is able to implement an output of a predetermined level or higher without using a reducer.

### SUMMARY OF THE INVENTION

In order to solve the problems described above, one object of the present disclosure is to provide a motor for a vehicle that can secure a predetermined output with a cogging torque minimized.

In addition, another object of the present disclosure is to provide a motor for a vehicle having a simple structure while providing a low cogging torque and a predetermined output.

Furthermore, yet another object of the present disclosure is to provide a steer-by-wire steering apparatus or a steering feedback actuator apparatus including a steering feedback motor that is able to secure a predetermined output with a cogging torque minimized.

In order to solve the problems described above, according to one embodiment, there can be provided a motor for a vehicle including: a motor housing; a motor shaft coupled with the motor housing to relatively rotate with respect to the motor housing; a dual rotor including an inner rotor and an outer rotor connected to the motor shaft; and a dual stator including an inner stator arranged on an inner side of the inner rotor and an outer stator arranged on an outer side of the outer rotor.

In addition, according to another embodiment, there can be provided a steering apparatus that is a steer-by-wire steering apparatus, the steering apparatus including: a road wheel actuator (RWA); and a steering feedback actuator (SFA), wherein the steering feedback actuator includes a steering wheel; a steering column connected to the steering wheel and a steering feedback motor that is connected to the steering column and is used for providing a steering feedback torque for the steering wheel, and wherein the steering feedback motor includes a motor shaft that is axially connected to the steering column, a dual rotor including an inner rotor and an outer rotor connected to the motor shaft, and a dual stator including an inner stator arranged on an inner side of the inner rotor and an outer stator arranged on an outer side of the outer rotor.

Furthermore, according to another embodiment, there can be provided a steering feedback actuator apparatus that is a steering feedback actuator (SFA) apparatus including a steer-by-wire steering apparatus and operates separately from a road wheel actuator (RWA), the steering feedback actuator apparatus including: a steering wheel; a steering column connected to the steering wheel; and a steering feedback motor that is connected to the steering column and is used for providing a steering feedback torque for the steering wheel, wherein the steering feedback motor includes a motor shaft that is axially connected to the steering column, a dual rotor including an inner rotor and an outer rotor connected to the motor shaft, and a dual stator including an inner stator arranged on an inner side of the inner rotor and an outer stator arranged on an outer side of the outer rotor.

At this time, a first slot-pole value defined as a least common multiple of the number of first poles of the inner rotor and the number of first slots of the inner stator and a second slot-pole value defined as a least common multiple of the number of second poles of the outer rotor and the number of second slots of the outer stator are different from each other.

In addition, an order of a cogging torque of the motor for the vehicle or the steering feedback motor can be determined in accordance with a least common multiple of the first slot-pole value and the second slot-pole value.

More specifically, it may be configured such that the number of the first poles is 6, the number of the first slots is 9, the number of the second poles is 10, the number of the second slots is 12, and the least common multiple of the first slot-pole value and the second slot-pole value is 180.

As another example, it may be configured such that the number of the first poles is 8, the number of the first slots is 9, the number of the second poles is 10, the number of the second slots is 12, and the least common multiple of the first slot-pole value and the second slot-pole value is 360.

In addition, a magnetic insulator may be additionally disposed between the inner rotor and the outer rotor.

According to embodiments of the present disclosure, a predetermined output can be secured while minimizing a cogging torque of a motor for a vehicle. In addition, according to embodiments of the present disclosure, a motor for a vehicle having a simple structure while providing a low cogging torque and a predetermined output.

Furthermore, according to embodiments of the present disclosure, an effect of securing a predetermined output with a cogging torque of a steering feedback motor being minimized in the steering feedback motor providing a feedback to a steering wheel in a steer-by-wire steering apparatus is provided.

### BRIEF DESCRIPTION OF THE DRAWINGS

FIG. 1 illustrates a schematic structure of a general electric power steering (EPS) system in which a motor is used.

FIG. 2 illustrates one example of the entire configuration of a Steer-By-Wire (SBW) steering apparatus to which this embodiment can be applied.

FIG. 3 illustrates another example of the entire configuration of a Steer-By-Wire (SBW) steering apparatus to which this embodiment can be applied.

FIG. 4 is a diagram illustrating an order of a cogging torque of a motor used in the steering apparatus illustrated in FIG. 3.

FIG. 5 is a perspective view of a motor for a vehicle according to this embodiment.

FIG. 6 is an enlarged perspective view of a part of the motor for a vehicle according to this embodiment.

FIG. 7 is a cross-sectional view of the motor for a vehicle taken along line I-I′ illustrated in FIG. 5.

FIG. 8 is a cross-sectional view of the motor for a vehicle taken along line II-II′ in FIG. 5.

FIG. 9 illustrates one example of slot-pole value of the motor for a vehicle according to this embodiment.

FIG. 10 illustrates another example of slot-pole value of the motor for a vehicle according to this embodiment.

FIG. 11 is an entire configuration diagram of a steer-by-wire steering apparatus in which a steering feedback motor according to this embodiment is used.

FIG. 12 is a graph illustrating changes in a cogging torque of the motor for a vehicle according to this embodiment.

### DETAILED DESCRIPTION OF THE INVENTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements. When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element.

Hereinafter, an embodiment will be described with reference to drawings.

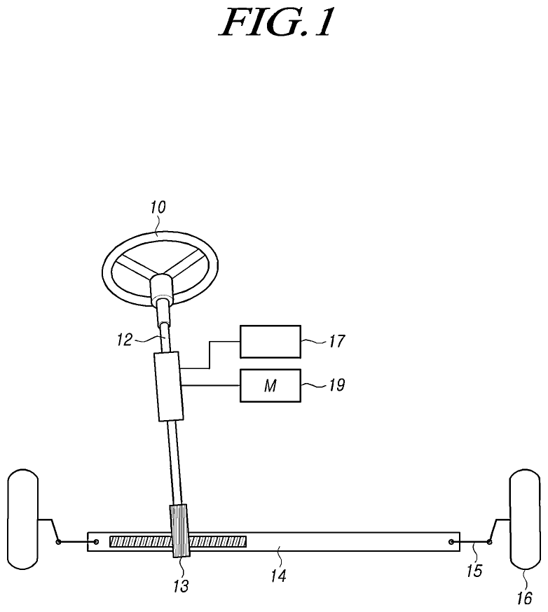

FIG. 1 illustrates a schematic structure of a general electric power steering (EPS) system in which a motor is used.

Referring to FIG. 1, an entire system relating to steering of a general vehicle includes a steering wheel (10) and a steering column assembly including a steering column (12) connected to the steering wheel, in which a pinion gear (13) is formed at the other end of the steering column (12). The entire system relating to steering of a vehicle includes a rack bar (14) in which a rack gear gear-coupled with the pinion gear of the steering column is formed, and left/right vehicle wheels (16) are connected to left and right sides of the rack bar (14) through tie rods (15)

If a driver rotates the steering wheel and the steering column, a gear structure connected thereto moves the rack bar to left and right sides, and a direction of vehicle wheels is changed in accordance therewith, whereby steering is performed.

In the EPS steering apparatus, in order to assist such driver's steering, a steering motor (19) is included. The steering motor (19) provides an assist steering force for rotating the steering column or moving the rack bar through a predetermined gear reduction structure (not illustrated).

In addition, a sensor (17) that is arranged to be adjacent to the steering column (12) is further included. The sensor (17) may include a torque sensor detecting a steering torque applied to the steering column by a driver, a steering angle sensor detecting a rotation angle of the steering column, and the like.

The EPS steering apparatus may include a column type (C-type) steering apparatus providing an assist steering force for the steering column (12) and a rack-type (R-type) steering apparatus providing an assist steering force for the rack bar (14) in accordance with a mounting position of the steering motor, and FIG. 1 illustrates the C-type steering apparatus.

A driver of such an EPS steering apparatus may include a steering motor (19) controlled by a controller and a reducer arranged between the steering motor and the steering column (12) or the rack bar (14).

The reducer (not illustrated) may include a worm-worm wheel type of a pulley-belt type and reduces rotation of an output shaft of the steering motor by a predetermined reduction ratio and transfers the reduced rotation to the steering column or the rack bar.

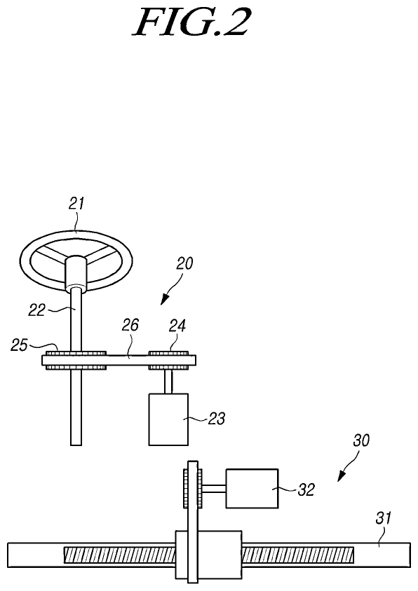

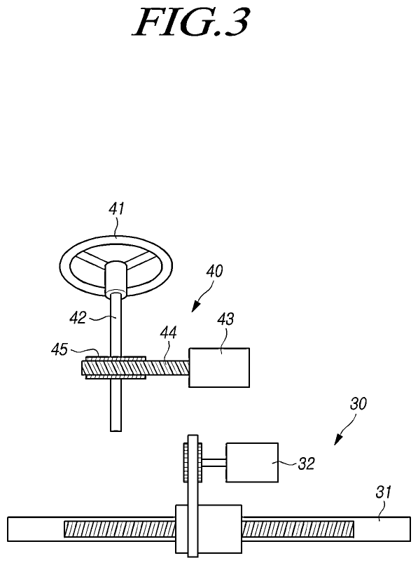

FIGS. 2 and 3 illustrate examples of the entire configuration of a Steer-By-Wire (SBW) steering apparatus to which this embodiment can be applied.

As one example of a steering system, there is a steering apparatus of a Steer-By-Wire (SBW) type in which steering wheel-side devices and drive-side device driving the rack bar are mechanically separated from each other.

Such an SBW steering apparatus includes a steering wheel-side assembly and a drive-side assembly, and the steering wheel-side assembly and the drive-side assembly are mechanically separated from each other.

The steering wheel-side assembly may include a Steering Feedback Actuator (SFA) that is used for providing a steering feeling (a vibration or the like) according to steering for the steering wheel in addition to the steering wheel and the steering column.

FIGS. 2 and 3 illustrate the entire configurations of such steer-by-wire steering apparatuses, which are different only in the form of a reducer.

The steer-by-wire steering apparatus illustrated in FIG. 2 includes a steering wheel-side assembly (20) and a drive-side assembly (30) that are two assemblies mechanically separated from each other.

The steering wheel-side assembly (20) includes a steering wheel (21), a steering column (22), and a steering feedback actuator that provides a feedback (reaction) torque for the steering column and the steering wheel.

The steering feedback actuator includes a feedback motor (23) and a reducer that reduces a rotation force of the feedback motor (23) and transfer the reduced rotation force to the steering column. The reducer includes a motor pulley (24) fixed to an output shaft of the feedback motor (23), a column pulley (25) fixed to the steering column, and a belt (26) connecting the two pulleys.

In other words, the steering feedback actuator of the steer-by-wire steering apparatus illustrated in FIG. 2 includes the reducer of the pulley-belt type.

Here, a diameter and a teeth number of the motor pulley (24) are smaller than a diameter and a teeth number of the column pulley (25), and a reduction ratio may be determined in accordance with a ratio thereof.

On the other hand, the drive-side assembly (30) includes a rack bar (31) connected between two vehicle wheels, a drive motor (32) providing a steering force by moving the rack bar (31), and a reducer connecting the drive motor (32) to the rack bar (31).

The reducer of the drive-side assembly (30) may be configured to include a belt and a ball nut.

When the steer-by-wire steering apparatus illustrated in FIG. 3 is compared with the apparatus illustrated in FIG. 2, only the structure of a reducer of the steering feedback actuator is different.

The steering wheel-side assembly (40) illustrated in FIG. 3 includes a steering wheel (41), a steering column (42), and steering feedback actuator that provides a feedback (reaction) torque for the steering column and the steering wheel.

The steering feedback actuator includes a feedback motor (43) and a reducer that reduces a rotation force of the feedback motor and transfers the reduced rotation force to the steering column. The reducer includes a worm shaft (44) that is coaxially connected to the output shaft of the feedback motor and a worm wheel (45) that is fixed to the steering column (42) and has gear teeth that are gear-coupled with the worm shaft (44).

In other words, the steering feedback actuator of the steer-by-wire steering apparatus illustrated in FIG. 3 includes a reducer of the worm-worm wheel type.

Here, a diameter and a teeth number of the worm shaft (44) are smaller than a diameter and a teeth number of the worm wheel (45), and a reduction ratio may be determined in accordance with a ratio thereof.

In the steer-by-wire steering apparatuses illustrated in FIGS. 2 and 3, steering drive for moving the rack bar using the driver-side assembly is performed, the drive-side assembly and the steering-side assembly are mechanically separated from each other, and thus it is necessary to provide a feedback for the steering wheel and the like in accordance with steering drive of the drive-side assembly.

For this, while steering drive is performed, the steering feedback actuator rotates the steering wheel and the steering column using the feedback motor and the reducer, thereby providing a feedback according to the steering drive for a driver.

At this time, the feedback motor and the reducer included in the steering feedback actuator need to provide outputs of a predetermined level or higher for providing an appropriate feedback torque.

In addition, for providing continuous feedback, a cogging torque of the feedback motor needs to be low.

The cogging torque causes a non-continuous rotation feeling when the motor rotation shaft is rotated at a low speed.

Generally, as the motor output becomes larger, the cogging torque becomes larger, and when the cogging torque becomes larger, a riffle torque at the time of driving a motor becomes larger, and it becomes difficult to perform motor control.

In the case of a vehicle motor in which a feedback according to a motor operation can be transferred to a driver, such a cogging torque needs to be minimized.

In the case of the steering feedback actuator of the steer-by-wire steering apparatus illustrated in FIG. 2 or 3, even if the output of the feedback motor is low more or less, the output is raised in accordance with a reduction ration of the reducer.

In other words, the steering feedback actuator of the steer-by-wire steering apparatus illustrated in FIG. 2 or 3 is able to provide a feedback torque output of a predetermined level or higher by using the reducer while maintaining the output of the feedback motor and the cogging torque to be low.

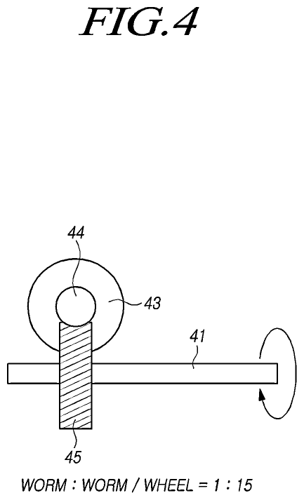

FIG. 4 is a diagram illustrating an order of a cogging torque of a motor used in the steering apparatus illustrated in FIG. 3.

FIG. 4 relates to a steering feedback actuator including the feedback motor (43) as illustrated in FIG. 3 and a reducer of the worm-worm wheel type.

In other words, it is assumed that a reducer including the worm shaft (44) connected to the output shaft of the feedback motor (43) and the worm wheel (45) that is gear-coupled therewith is used, and a reduction ratio at the time of reduction is 15:1. In other words, when the worm shaft (44) rotates once, the worm wheel (45) and the steering column (41) connected thereto are rotated by 24 degrees.

The feedback motor (43) used in FIG. 4 may include a stator provided in a motor housing and a rotor provided in the motor output shaft.

The stator has a metal wounded by a winding and is magnetized in accordance with supply of a current from the outside, and the rotor may include a permanent magnet.

It is assumed that the number of slots of the stator of the feedback motor (43) illustrated in FIG. 4 is 12, and the number of poles of the rotor is 8. In other words, the feedback motor (43) illustrated in FIG. 4 may be represented as a 8-pole 12-slot motor.

The least common multiple of 8, which is the number of poles of the feedback motor (43), and 12, which is the number of slots, is 24, and this may be defined as a slot-pole value.

As the slot-pole value of such a feedback motor (43) becomes smaller, a frequency of a change in the cogging torque may be decreased. For example, in a case in which a motor output shaft is forcibly rotated without any external power, while a discontinuous change in cogging torque may occur 24 times per rotation in a case where the slot-pole value is 24, in a case where the slot-pole value is 10, a discontinuous change in cogging torque may occur 10 times per rotation. In this way, the frequency of a change in cogging torque of a motor may be expressed by an order of the cogging torque, and, in description here, in the case of a steering feedback actuator using a reducer, the number of discontinuous changes in the cogging torque during one rotation (360 degrees rotation) of the steering column (41) fixed to the worm wheel (24) and a steering wheel connected thereto according to rotation of a motor output shaft is defined as an order of the cogging torque. In the case of a feedback motor and a steering feedback actuator using a coaxial motor, in which a motor shaft and a steering column are coaxially arranged, that do not use no reducer, the number of discontinuous changes in the cogging torque during one rotation (360 degrees rotation) of a motor output shaft is defined as an order of the cogging torque.

An order of cogging torque may be in proportion to a slot-pole value that is a least common multiple of the number of slots of a stator of a motor and the number of poles of a motor rotor.

In the case of such a feedback motor (43) illustrated in FIG. 4, 24 changes in cogging torque occur during one rotation of the output shaft of the feedback motor, in other words, rotation of 360 degrees, and the reduction ratio of the reducer is 15:1, and thus a total of 24 discontinuous changes in cogging torque occur during a rotation of the worm wheel (45) by 24 degrees.

Consequently, while the steering column (41) fixed to the worm wheel (45) and the steering wheel connected thereto rotate once (360 degrees), a total of 24*15=360 discontinuous changes in the cogging torque occur.

Generally, as an order of the cogging torque becomes lower, a magnitude of the cogging torque tends to further increase.

Thus, as an order of cogging torque of the steering feedback actuator becomes lower, a magnitude of the cogging torque further increases, and a change in torque of the feedback felt by a driver becomes larger, whereby a feedback feeling becomes bad.

In the case of the steering feedback actuator illustrated in FIG. 4, an order of the cogging torque is 360 which is a relatively high value, and thus a magnitude of the cogging torque becomes small, and a change in torque of the feedback felt by a driver becomes small. Thus, a good steering feedback feeling can be provided.

However, in the case of the steering feedback actuator as illustrated in FIGS. 2 to 4, in order to secure an output of a predetermined level or higher and an order of the cogging torque, a separate reducer needs to be used in addition to the feedback motor.

According to the use of such a reducer, the steering feedback actuator becomes mechanically complicated, and the cost may increase.

In addition, due to the use of a reducer, the size of the steering feedback actuator becomes large, and thus there are disadvantages from aspects of packaging with other components and layouts.

In order to solve such problems, a coaxial motor, in which a motor shaft and a steering column are coaxially arranged, using no reducer may be used as a feedback motor.

However, generally, while a coaxial motor has a structure in which one rotor connected to a motor output shaft and one stator connected to a housing are included, a desired feedback output cannot be secured in such a coaxial motor, and there is a certain limitation on an increase of an order of cogging torque.

Thus, the present disclosure proposes a motor for a vehicle capable of providing an output of a predetermined level or higher while minimizing a cogging torque felt by a driver like a steering feedback actuator using a reducer or the like even if a coaxial motor using no reducer is used as a feedback motor in a steer-by-wire steering apparatus.

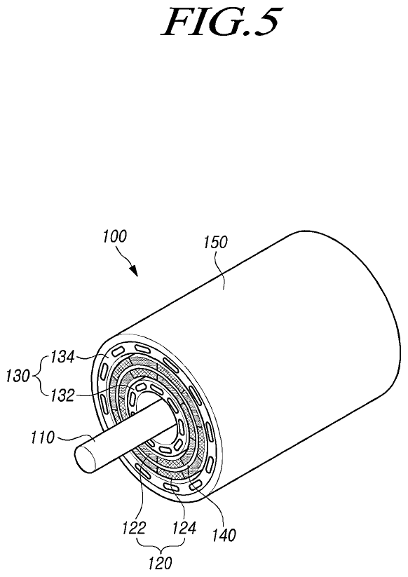

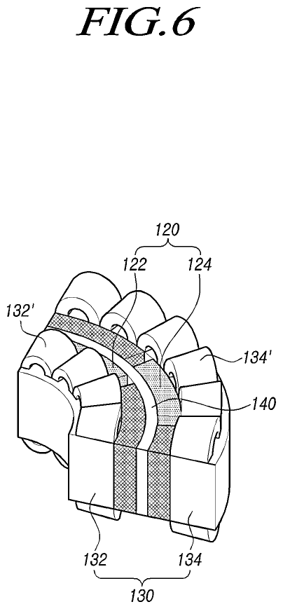

FIG. 5 is a perspective view of a motor for a vehicle according to this embodiment, and FIG. 6 is an enlarged perspective view of a part of the motor for a vehicle according to this embodiment.

The motor (100) for a vehicle according to this embodiment may be configured to include: a motor housing (150); a motor shaft (110) that is coupled with the motor housing such that it relatively rotates with respect to the motor housing; a dual rotor (120) including an inner rotor (122) that is connected to the motor shaft and an outer rotor (124); and a dual stator (130) including an inner stator (132) that is disposed on an inner side of the inner rotor (122) and an outer stator (134) disposed on an outer side of the outer rotor (124).

In other words, the motor (100) for a vehicle according to this embodiment has a structure including a dual rotor having two rotors that are radially arranged on inner/outer sides and a dual stator having two stators that are radially arranged on inner/outer sides of the dual rotor.

The motor housing (150) is a cylindrical hollow housing, and the outer stator (134) of the dual stator (130) is fixed and mounted to an inner face of the motor housing.

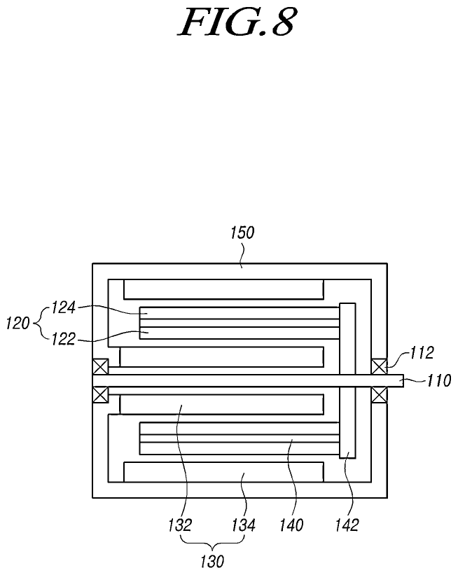

The dual rotor (120) is fixedly coupled with the motor shaft (110) using a predetermined connecting structure (142 illustrated in FIG. 8).

The inner rotor (122) of the dual rotor (120) has Pi poles, the outer rotor (124) has Po poles, and the inner rotor (122) and the outer rotor (124) may include many magnets.

More specifically, the inner rotor (122) may be formed as a circular structure in which an N-pole permanent magnet and an S-pole permanent magnet are alternately arranged.

In the inner rotor (122), a total number Pi/2 of N-pole magnets and a total number Pi/2 of S-pole magnets are arranged, and a total number Pi of poles are included. In other words, the number of first poles of the inner rotor (122) is Pi.

Similarly, the outer rotor (124) may be formed as a circular structure in which an N-pole permanent magnet and an S-pole permanent magnet are alternately arranged. In the outer rotor (124), a total number Po/2 of N-pole magnets and a total number Po/2 of S-pole magnets are arranged, and a total number Po of poles are included. In other words, the number of second poles of the outer rotor (124) is Po.

The inner rotor (122) and the outer rotor (124) are mechanically connected to each other, and a magnetic insulator (140) formed of a material through which a magnetic field cannot pass is disposed between the inner rotor (122) and the outer rotor (124).

The magnetic insulator (140) has a circular cylindrical shape, and the inner rotor (122) is coupled with an inner face of the magnetic insulator (140), and the outer rotor (124) is coupled with an outer face of the magnetic insulator (140).

The magnetic insulator (140) is a structure for separating a magnetic field according to the permanent magnets of the inner rotor (122) and a magnetic field according to the permanent magnets of the outer rotor (124) from each other and may be produced using a permalloy alloy that has a magnetic shielding characteristic and has high magnetic permeability or the like.

The dual stator (130) includes the inner stators (132) and the outer stators (134) that are separately arranged in a radial pattern.

The inner stator (132) is arranged in a cylindrical shape right the outer side of the motor shaft (110) in a center area of the motor housing (150).

The outer stator (134) may be attached to an inner face of the motor housing (150).

The inner stator (132) has a first coil structure (132′) in which a coil is wound around cores corresponding to the number of first slots Si. In addition, the outer stator has a second coil structure (134′) in which a coil is wound around cores corresponding to the number of second slots So.

In other words, the number of first slots of the inner stator (132) can be defined as Si, and the number of second slots of the outer stator (134) can be defined as So.

The first coil structure (132′) of the inner stator (132) and the second coil structure (134′) of the outer stator (134) are applied with currents having different magnitudes or phases and are magnetized in accordance therewith.

The inner stator (132) provides a predetermined first rotation force for the inner rotor (122) in accordance with a change in the magnetic force with the inner rotor (122), and the outer stator (134) provides a predetermined second rotation force for the outer rotor (124) in accordance with a change in the magnetic force with the outer rotor (124).

Consequently, an output is applied to the motor shaft (110) fixed to the dual rotor (120) based on a rotation force acquired by the first rotation force and the second rotation force, and thus an output of the motor increases.

Particularly, the motor (100) for a vehicle according to this embodiment may be a three-phase motor, and, in such a case, the number of first slots Si of the inner stator (132) and the number of second slots So of the outer stator may be configured to be multiples of 3.

In other words, currents of three phases having the same magnitudes and different phases u, v, and w are applied to the inner and outer stators, and thus the numbers of slots of the inner and outer stators need to be multiples of 3.

According to this embodiment, in order to increase an order of the cogging torque, a first slot-pole value defined as a least common multiple of the number of first poles Pi of the inner rotor (122) and the number of first slots Si of the inner stator (132) and a second slot-pole value defined as a least common multiple of the number of second poles Po of the outer rotor (124) and the number of second slots So of the outer stator (134) may have mutually-different values.

In addition, the cogging torque of the motor (100) for a vehicle may be determined using the least common multiple of the first slot-pole value and the second slot-pole value. For example, if an order of the cogging torque of the motor (100) for a vehicle is determined in accordance with the least common multiple of the first slot-pole value and the second slot-pole value, a magnitude of the cogging torque that is inversely proportional to the order of the cogging torque may be determined, and the cogging torque may be determined in accordance with the order of the cogging torque and the magnitude of the cogging torque. In other words, a magnitude of the cogging torque is determined in accordance with an order of the cogging torque. Thus, as the order of the cogging torque becomes higher, the cogging torque of which the magnitude is smaller may be determined. In order to raise the order of the cogging torque of the motor (100) for a vehicle, it is preferable that a least common multiples of the first slot-pole value and the second slot-pole value be at least 180 or more.

More specifically, the number of first poles Pi is 6, the number of first slots Si is 9, the number of second poles Po is 10, the number of second slots So is 12, and a least common multiple of the first slot-pole value and the second slot-pole value may be 180. For example, since the number of first poles Pi is 6, and the number of first slots Si is 9, the first slot-pole value is 18, the number of second poles Po is 10, and the number of second slots So is 12, the second slot-pole value is 60, and thus a least common multiple of the first slot-pole value and the second slot-pole value may be 180.

It is more preferable that the number of first poles Pi be 8, the number of first slots Si be 9, the number of second poles Po be 10, the number of second slots So be 12, and a least common multiple of the first slot-pole value and the second slot-pole value may be 360. For example, since the number of first poles Pi is 8, and the number of first slots Si is 9, the first slot-pole value is 72, the number of second poles Po is 10, and the number of second slots So is 12, the second slot-pole value is 60, and thus a least common multiple of the first slot-pole value and the second slot-pole value may be 360.

In a case in which the least common multiple of the first slot-pole value and the second slot-pole value is 360, the number of changes in the cogging torque during one rotation of the motor shaft, in other words, a frequency of changes in the cogging torque or an order of the cogging torque is 360.

In the case of an existing coaxial motor, there is a predetermined limitation on an increase in the order of the cogging torque, and if the order of the cogging torque is low, the magnitude of the cogging torque is large, and deterioration of a driver's operation feeling may occur. Thus, in this embodiment, by configuring the order of the cogging torque defined as a least common multiple of the first slot-pole value and the second slot-pole value to be equal to or larger than 180, the structure of the motor (100) for a vehicle can be simplified by minimizing the deterioration of an operation feeling according to driver's recognition of the cogging torque and, at the same time, including a coaxial motor structure using no reducer.

In addition, if the motor (100) for a vehicle according to this embodiment is used as a feedback motor of a steering feedback actuator (SFA) of the steer-by-wire steering apparatus, the motor has a coaxial motor structure in which the steering column is directly connected to the motor shaft (100), and thus, the steering wheel connected to the steering column rotates once during one rotation of the motor shaft (110).

Generally, if the same motor output is assumed in a coaxial motor, as the order of cogging torque becomes higher, an amount of change in the cogging torque for one time further decreases.

Consequently, in a case where a least common multiple of the first slot-pole value and the second slot-pole value is 360, there are changes of 360 times in the cogging torque during one rotation of the steering wheel, and thus, a feedback feeling felt by a user can be improved.

For example, as a comparative example, in the case of a coaxial motor in which one rotor and one stator are included, the number of poles of the rotor is 8, and the number of slots of the stator is 12, a slot-pole value that is a least common multiple of the 8 poles and the 12 slots of the coaxial motor is 24. Thus, the order of the cogging torque is 24 as well.

In the case of the coaxial motor according to such a comparative example, non-continuous torque changes, that is, cogging torque changes of 24 times during one rotation of the steering wheel (the motor shaft) occur, and an amount of change in the cogging torque, that is, a magnitude increases based on the number of times of changes in the cogging torque that is relatively low, and a feedback feeling felt by a driver may deteriorate.

On the other hand, according to this embodiment, in a case where a least common multiple of the first slot-pole value and the second slot-pole value is 360, cogging torque changes of 360 times occur during one rotation of the steering wheel, and an amount of change in the cogging torque, that is, a magnitude decreases based on the number of times of changes in the cogging torque that is relatively high, and a feedback feeling felt by a driver can be improved.

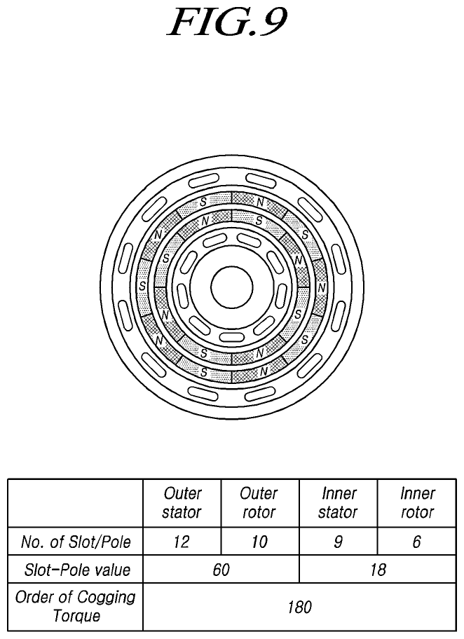

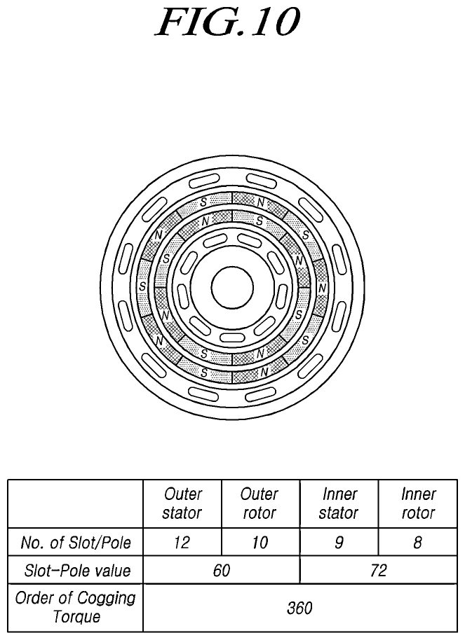

A specific embodiment of the order of cogging torque that is determined using a first slot-pole value and a second slot-pole value and a least common multiple thereof will be described below in more detail with reference to FIGS. 9 and 10.

If this embodiment as described above is used, by using a motor for a vehicle including the dual rotor (120) that includes an inner and outer rotors radially arranged inside and outside and the dual stator (130) that includes inner and outer stators radially arranged inside and outside, compared to a coaxial motor having a single rotor-stator, a relatively high output and a relatively high order of cogging torque can be provided.

Thus, by using such a motor for a vehicle, by decreasing an amount of change in cogging torque and raising the order of the cogging torque, a smooth motor rotation can be achieved.

Particularly, in a case where the motor for a vehicle according to this embodiment is used as a feedback motor of a steering feedback actuator (SFA) of a steer-by-wire steering apparatus, a feedback feeling felt in the steering wheel can be enhanced. However, the motor for a vehicle according to this embodiment is not limited to being used as a feedback motor of a steering feedback actuator of a steer-by-wire steering apparatus. In other words, this motor for a vehicle may be applied also to other motors requiring a high order of cogging torque and a large output among motors used in vehicles, for example, a motor for a traveling apparatus, a motor for a braking apparatus, a motor for a transmission, and the like.

Particularly, the motor for a vehicle according to this embodiment is useful in a case where cogging torque according to motor rotation can be recognized by a vehicle passenger. For example, the motor for a vehicle according to this embodiment may be used for a motor for operations of an motorized chair, a motor for operations of rear-view mirrors, and the like.

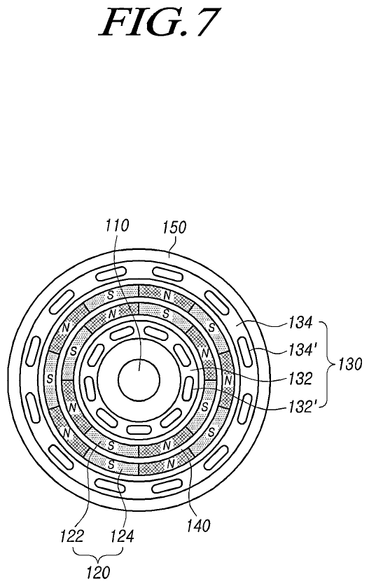

FIG. 7 is a cross-sectional view of the motor for a vehicle taken along line I-I′ illustrated in FIG. 5, and FIG. 8 is a cross-sectional view of the motor for a vehicle taken along line II-II′ in FIG. 5.

FIG. 7 is a cross-sectional view of the motor for a vehicle according to this embodiment taken in a horizontal direction perpendicular to a motor shaft, and FIG. 8 is a cross-sectional view taken in a longitudinal direction parallel to the motor shaft.

As illustrated in FIGS. 7 and 8, in the motor for a vehicle according to this embodiment, a motor shaft (110) is arranged at the center, and a dual rotor (120) is arranged to be mechanically coupled with the motor shaft.

The dual rotor (120) is mechanically coupled with the motor shaft through a connector (142) and has a hollow cylindrical shape.

The dual rotor (120) includes an inner rotor (122) that is radially arranged on the inner side and an outer rotor (124) that is radially arranged on the outer side. A magnetic insulator (140) may be arranged between the inner rotor (122) and the outer rotor (124).

The inner rotor (122) may be formed by alternately arranging N-pole magnets and S-pole magnets corresponding to a number of first poles Pi, and the outer rotor (124) may be formed by alternately arranging N-pole magnets and S-pole magnets corresponding to a number of second poles Po.

Although not illustrated, the inner rotor (122) and the outer rotor (124) may further include a circular pocket structure that houses many magnets. In other words, many magnet housing grooves are formed in the circular pocket structure, and many bar-type N/S pole magnets are housed in the magnet housing grooves, whereby the inner rotor (122) or the outer rotor (124) may be formed.

In a space between the inner rotor (122) and the motor shaft (110), inner stators (132) corresponding to the number of first slots Si are disposed.

The inner stator (132) may include Si winding bodies (132′) in which a coil is wound around cores corresponding to the number of first slots Si. The inner stator (132) is arranged to be mechanically connected to the motor housing (150) and is magnetized in accordance with reception of a current signal from a drive circuit such as an external motor inverter.

In accordance with a coil of each slot of the inner stator (132) being magnetized over time, a first magnetic force is applied to the inner rotor (122) adjacent thereto. A first rotation force is applied to the inner rotor (122) in accordance with the first magnetic force, and the motor shaft (110) is rotated in accordance with the first rotation force.

In addition, in a space between the outer rotor (124) and the motor housing (150), that is, radial outer-side positions of the outer rotor (124), outer stators (134) corresponding to the number of second slots So are disposed.

The outer stator (134) may include So winding bodies (134′) in which a coil is wound around cores corresponding to the number of second slots So. The outer stator (134) is fixedly arranged on an inner face of the motor housing (150) and is magnetized in accordance with reception of a current signal from a drive circuit such as an external motor inverter.

In accordance with a coil of each slot of the outer stator (134) being magnetized over time, a second magnetic force is applied to the outer rotor (124) adjacent thereto. A second rotation force is applied to the outer rotor (124) in accordance with the second magnetic force, and the motor shaft (110) is rotated in accordance with the second rotation force.

Consequently, a torque is supplied to the motor shaft (110) based on a rotation force acquired by adding the first rotation force and the second rotation force together, and an output thereof is able to be increased compared with a coaxial motor having a single rotor/stator structure.

Bearings (112) are arranged between a center flange of the motor housing (150) and the motor shaft (110), and the motor shaft (110) can rotate with respect to the motor housing (150).

In the embodiment illustrated in FIGS. 5 to 8, although it is illustrated that the number of first poles Pi of the inner rotor (122) of the motor for a vehicle is 8, the number of second poles Po of the outer rotor (124) is 10, the number of first slots Si of the inner stator (132) is 9, and the number of second slots So of the outer stator (134) is 12, the configuration is not limited thereto.

However, in the motor for a vehicle according to this embodiment, the first slot-pole value that is a least common multiple of the number of first poles and the number of first slots Si and the second slot-pole value that is a least common multiple of the number of second poles and the number of second slots have mutually-different values.

In addition, a combination of values of a ½ pole value and a ½ slot value that is defined as an order of cogging torque may be used such that a least common multiple of the first slot-pole value and the second slot-pole value is equal to or larger than 180.

FIGS. 9 and 10 illustrate examples of the slot-pole value of the motor for a vehicle according to this embodiment.

In the embodiment illustrated in FIG. 9, the number of first poles Pi of the inner rotor (122) of the motor for a vehicle is 6, the number of second poles Po of the outer rotor (124) is 10, the number of first slots Si of the inner stator (132) is 9, and the number of second slots So of the outer stator (134) is 12.

Thus, in the motor for a vehicle according to the embodiment illustrated in FIG. 9, the first slot-pole value that is a least common multiple of the number of first poles and the number of first slots is 18. The second slot-pole value that is a least common multiple of the number of second poles and the number of second slots is 60, which is different from the first slot-pole value.

In addition, according to the embodiment illustrated in FIG. 9, a least common multiple of 18 that is the first slot-pole value and 60 that is the second slot-pole value, which is an order of cogging torque, is 180.

Thus, in the motor for a vehicle according to the embodiment illustrated in FIG. 9, changes of 180 times in cogging torque occur during one rotation of the motor shaft (110). In other words, a change in the cogging torque occurs once every time the motor shaft rotates by 2 degrees.

On the other hand, in the embodiment illustrated in FIG. 10, the number of first poles Pi of the inner rotor (122) of the motor for a vehicle is 8, the number of second poles Po of the outer rotor (124) is 10, the number of first slots Si of the inner stator (132) is 9, and the number of second slots So of the outer stator (134) is 12.

Thus, in the motor for a vehicle according to the embodiment illustrated in FIG. 10, the first slot-pole value that is a least common multiple of the number of first poles and the number of first slots is 72. The second slot-pole value that is a least common multiple of the number of second poles and the number of second slots is 60, which is different from the first slot-pole value.

In addition, according to the embodiment illustrated in FIG. 10, a least common multiple of 72 that is the first slot-pole value and 60 that is the second slot-pole value, which is an order of cogging torque, is 360.

Thus, in the motor for a vehicle according to the embodiment illustrated in FIG. 10, changes of 360 times in cogging torque occur during one rotation of the motor shaft (110). In other words, a change in the cogging torque occurs once every time the motor shaft rotates by 1 degrees.

If the motor for a vehicle illustrated in FIG. 9 or 10 is used as a feedback motor of a steering feedback actuator (SFA) of a steer-by-wire steering apparatus, a cogging torque changes of 180 times (the embodiment illustrated in FIGS. 9) and 360 times (the embodiment illustrated in FIG. 10) occurs during one rotation of the steering wheel.

Thus, in a case where a feedback force is applied to the steering wheel, a cogging torque having a small magnitude occurs every time the steering wheel rotates by 2 degrees or 1 degrees, and thus a driver recognizes that a feedback force is continuously provided, and accordingly, the feedback feeling can be enhanced. The following Table 1 illustrate exemplary cases of combinations of slot-pole values and orders of cogging torque which can be compared with the embodiments illustrated in FIGS. 9 and 10.

TABLE 1
Comparative examples of this embodiment

| | | Outer | Outer | Inner | Inner |
|---|---|---|---|---|---|
| | | Stator (So) | Rotor (Po) | Stator (Si) | Rotor (Pi) |
| CASE | number of slots/number of poles | 12 | 8 | 9 | 6 |
| 1 | slot-pole value | 24 | | 18 | |
| | order of cogging torque | 72 | | | |
| CASE | number of slots/number of poles | 12 | 8 | 9 | 8 |
| 2 | slot-pole value | 24 | | 72 | |
| | order of cogging torque | 72 | | | |
| CASE | number of slots/number of poles | 12 | 10 | 12 | 8 |

| | | | |
|---|---|---|---|
| 3 | slot-pole value | 60 | 24 |

| | |
|---|---|
| order of cogging torque | 120 |

In Case 1 as a comparative example, a first slot-pole value and a second slot-pole value are respectively 18 and 24, and an order of cogging torque is 72 that is a least common multiple of 18 and 24. In Case 2, a first slot-pole value and a second slot-pole value are respectively 72 and 24, and an order of cogging torque is 72 that is a least common multiple of 72 and 24.

Thus, in a case where the dual rotors according to Case 1 and Case 2, which are comparative examples and a motor for a vehicle having a dual stator structure are used as feedback motors, changes of 72 times in cogging torque occur during one rotation of the steering wheel, and a change in cogging torque occurs every time the steering wheel rotates by 5 degrees, and thus, compared with the embodiments illustrated in FIGS. 9 and 10, a relatively high cogging torque is generated.

Accordingly, when compared with the embodiments illustrated in FIGS. 9 and 10, in Case 1 and Case 2 that are comparative examples, a degree of discontinuity of a feedback torque, that is, a cogging torque felt by a driver at the time of providing a feedback torque, is large, and a feedback feeling may deteriorate.

In addition, in Case 3 as a comparative example, a first slot-pole value and a second slot-pole value are respectively 24 and 60, and an order of the cogging torque is 120 which is a least common multiple of 24 and 60. Thus, in a case where the motor for a vehicle according to Case 3 that is a comparative example is used as a feedback motor, changes of 120 times in cogging torque occur during one rotation of the steering wheel, and a change in cogging torque occurs every time the steering wheel rotates by 3 degrees, and thus, compared with the embodiments illustrated in FIGS. 9 and 10, a relatively high cogging torque is generated.

Accordingly, when compared with the embodiments illustrated in FIGS. 9 and 10, also in Case 3 that is a comparative example, a degree of discontinuity of a feedback torque, that is, a cogging torque felt by a driver at the time of providing a feedback torque, is large, and a feedback feeling may deteriorate.

In this way, according to this embodiment, while a motor for a vehicle including the dual rotor (120) including inner and outer rotors that are radially arranged inside and outside and the dual stator including (130) including inner and outer stators that are radially arranged inside and outside is provided, and a combination of pole values and slot values of the inner and outer rotors and the inner and outer stators is used such that the order of cogging torque is equal to or higher than 180.

In this way, a high order of cogging torque is provided together with a high motor output, whereby discontinuity of a feeling for a motor operation according to a cogging torque can be decreased.

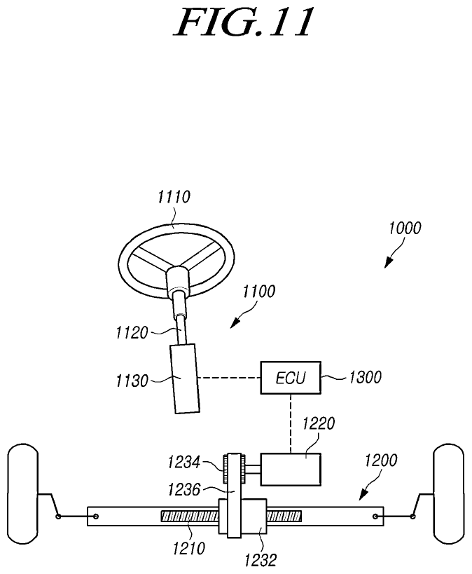

FIG. 11 is an entire configuration diagram of a steer-by-wire steering apparatus (1000) in which a steering feedback motor according to this embodiment is used.

Referring to FIG. 11, the steer-by-wire steering apparatus (1000) according to this embodiment may include a road wheel actuator (RWA; 1200), a steering feedback actuator (SFA; 1100), a controller (1300), and the like.

The road wheel actuator (1200) may include a steering motor (1220) and a reducer that transfers a drive force of the steering motor to a rack bar (1210).

A motor pulley (1234) is provided in a motor shaft of the steering motor (1220), and the reducer may include a ball nut (1232) that is rotatably coupled with the rack bar (1210) and a drive belt (1236) connecting a nut pulley provided in the ball nut and the motor pulley (1234).

However, the reducer of the road wheel actuator (1200) is not limited to such a structurer, and a reducer of a pinion-rack rear coupling system may be used as well.

The steering feedback actuator (1100) is an apparatus causing a driver to feel a steering feedback by proving a feedback corresponding to a steering force provided by the road wheel actuator (1200) for a steering column.

The steering feedback actuator (1100) may include a steering column (1120) connected to the steering wheel (1110) and a steering feedback motor (1130) that is connected to the steering column and is used for providing a steering feedback torque for the steering wheel

Here, the steering feedback motor (1130) is a coaxial motor including a dual rotor and a dual stator according to the embodiments illustrated in FIGS. 5 to 10.

More specifically, the steering feedback motor (1130) may be a coaxial motor that includes a motor shaft that is coaxially connected to the steering column (1120), a dual rotor including an inner rotor and an outer rotor connected to the motor shaft, and a dual stator including an inner stator arranged on an inner side of the inner rotor and an outer stator arranged on an outer side of the outer rotor.

In such a case, a first slot-pole value defined as a least common multiple of the number of first poles Pi of the inner rotor and the number of first slots Si of the inner stator and a second slot-pole value defined as a least common multiple of the number of second poles Po of the outer rotor and the number of second slots So of the outer stator may be different from each other.

An order of cogging torque of the steering feedback motor (1130) may be determined using a least common multiple of the first slot-pole value and the second slot-pole value, and the least common multiple of the first slot-pole value and the second slot-pole value may be at least 180 or more.

A specific configuration of such a steering feedback motor (1130) is the same as the configuration of the motor for a vehicle described with reference to FIGS. 5 to 10, in order to avoid duplicate, detailed description thereof will be omitted.

The controller (1300) has a function of generating a steering motor drive current in accordance with a target torque command provided by a domain control unit (DCU) or the like and applying the generated drive current to the steering motor (1220). In a case where a steering force is applied to the rack bar by driving the steering motor (1220), the controller (1300) may generate a feedback torque signal that is in proportion to the applied steering force and control the steering feedback motor (1130) based on the generated feedback torque signal.

On the other hand, in a case where an abnormality is detected in one of the inner stator and the outer stator of the steering feedback motor (1130), the controller (1300) may apply a current using the remaining stator that is in a normal state.

Thus, even in a case where a malfunction occurs in one of the dual stator, a fail-safe operation can be performed using a normal stator. In other words, according to this embodiment, while a motor output and an order of cogging torque are increased by duplicating stators of the steering feedback motor (1130), the steering feedback motor (1130) is controlled using an output of about 50% even in a case where a malfunction has occurred in one stator of the dual stator, whereby the stability can be strengthened.

The steering feedback motor (1130) according to this embodiment may include a first inverter used for applying a control current to the inner stator and a second inverter used for applying a control current to the outer stator.

In other words, in order to drive the steering feedback motor (1130) according to this embodiment, the first inverter may generate a first control current and applies the first control current to a winding of each slot of the inner stator, and the second inverter operating separately from the first inverter may generate a second control current and apply the second control current to a winding of each slot of the outer stator.

In the steering feedback actuator (1100) as illustrated in FIG. 11 and the steer-by-wire steering apparatus (1000) including the steering feedback actuator can use a coaxial motor having a dual rotor-stator structure as a steering feedback motor without requiring an additional reducer.

Thus, by decreasing the size and the degree of complexity of the steering feedback actuator (1100) and the steer-by-wire steering apparatus, flexibility of packaging or layout design can be enhanced.

In addition, by providing a steering feedback motor having a high output and a high order of cogging torque, a steering feedback feeling provided for a driver can be improved.

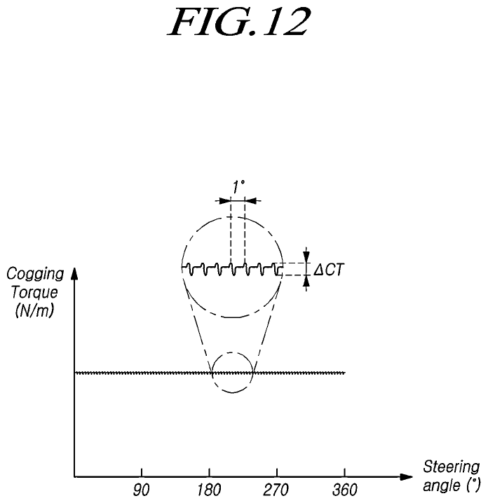

FIG. 12 is a graph illustrating changes in a cogging torque of the motor for a vehicle according to this embodiment.

More specifically, the graph represented in FIG. 12 illustrates changes in the cogging torque acquired in a case where the motor for a vehicle according to the embodiment illustrated in FIG. 10 is used as a steering feedback motor.

As in the embodiment illustrated in FIG. 10, in a case where the least common multiple of the first slot-pole value and the second slot-pole value is 360, the number of times of changes in the cogging torque, that is, a frequency of changes in the cogging torque or an order of the cogging torque during one rotation of the motor shaft is 360.

In such a case, as illustrated in FIG. 12, changes of about 360 times in the cogging torque occur while the steering angle is changed by 360 degrees in accordance with rotation of the steering feedback motor.

In other words, as illustrated in the enlarged diagram of FIG. 12, during a change of the steering angle by 1 degrees, a change of one time in the cogging torque, that is, a rising and a falling occur.

As the order of the cogging torque, that is, the number of times of changes in the cogging torque occurring during one rotation of the motor further increases, the amount change in the cogging torque decreases further.

Thus, as in FIG. 12, in a case where the least common multiple of the first slot-pole value and the second slot-pole value is 360, a change in the cogging torque having a relatively small magnitude frequently occurs, and, consequently, a feeling of a feedback felt by a driver through the steering wheel can be improved.

Although all the constituent elements configuring the embodiments of the present disclosure have been described as being coupled as one or operating in combination, these embodiments are not necessarily limited to such embodiments. In other words, constituent elements may operate by selectively combining one or more of all the constituents within the objects of the present disclosure. In addition, although each of all the constituent elements can be realized by independent hardware, by selectively combining some or all of the constituent elements, the constituent elements may be realized as a computer program having program modules performing functions of the combined some or all of the constituent elements in one or a plurality of pieces of hardware. Codes and code segments constituting the computer program can be easily inferred by a person skilled in the art of a technical field of the present disclosure. Such a computer program can realize an embodiment of the present disclosure by being stored in computer-readable media and read and executed by a computer. The media of the computer program may include a magnetic recording media, an optical recording medium, a carrier wave media, and the like.

In addition, a term such as “include”, “configure”, “have”, or the like described above means that a corresponding constituent element may be included unless otherwise mentioned, and accordingly, it should be interpreted such that other constituent elements are not excluded, and other constituent elements may be further included. All the terms including technical and scientific terms, unless otherwise defined, have the same meanings as those that are generally understood by a person skilled in the art to which the present disclosure belongs. Terms such as terms defined in dictionaries that are generally used should be interpreted to coincide with meanings in the context of related arts and, unless clearly defined in these embodiments, should not be interpreted as having an ideal or excessively formal meaning.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. T us, the scope of the present disclosure is not limited to the embodiments shown, but is to be accorded the widest scope consistent with the claims. The scope of protection of the present disclosure should be construed based on the following claims, and all technical ideas within the scope of equivalents thereof should be construed as being included within the scope of the present disclosure.

What is claimed is:

1. A motor for a vehicle comprising:
a motor housing;
a motor shaft coupled with the motor housing to relatively rotate with respect to the motor housing;
a dual rotor including an inner rotor and an outer rotor connected to the motor shaft; and
a dual stator including an inner stator arranged on an inner side of the inner rotor and an outer stator arranged on an outer side of the outer rotor.

2. The motor for a vehicle according to claim 1, wherein a first slot-pole value defined as a least common multiple of the number of first poles of the inner rotor and the number of first slots of the inner stator and a second slot-pole value defined as a least common multiple of the number of second poles of the outer rotor and the number of second slots of the outer stator are different from each other.

3. The motor for a vehicle according to claim 2, wherein a cogging torque of the motor for the vehicle is determined in accordance with a least common multiple of the first slot-pole value and the second slot-pole value.

4. The motor for a vehicle according to claim 3, wherein the number of the first poles is 6, the number of the first slots is 9, the number of the second poles is 10, the number of the second slots is 12, and the least common multiple of the first slot-pole value and the second slot-pole value is 180.

5. The motor for a vehicle according to claim 3, wherein the number of the first poles is 8, the number of the first slots is 9, the number of the second poles is 10, the number of the second slots is 12, and the least common multiple of the first slot-pole value and the second slot-pole value is 360.

6. The motor for a vehicle according to claim 1, further comprising a magnetic insulator disposed between the inner rotor and the outer rotor.

7. A steering apparatus that is a steer-by-wire steering apparatus, the steering apparatus comprising:
a road wheel actuator (RWA); and
a steering feedback actuator (SFA),
wherein the steering feedback actuator includes a steering column connected to a steering wheel and a steering feedback motor that is connected to the steering column and is used for providing a steering feedback torque for the steering wheel, and
wherein the steering feedback motor includes a motor shaft that is axially connected to the steering column, a dual rotor including an inner rotor and an outer rotor connected to the motor shaft, and a dual stator including an inner stator arranged on an inner side of the inner rotor and an outer stator arranged on an outer side of the outer rotor.

8. The steering apparatus according to claim 7, wherein a first slot-pole value defined as a least common multiple of the number of first poles of the inner rotor and the number of first slots of the inner stator and a second slot-pole value defined as a least common multiple of the number of second poles of the outer rotor and the number of second slots of the outer stator are different from each other.

9. The steering apparatus according to claim 8, wherein an order of a cogging torque of the steering feedback motor is determined in accordance with a least common multiple of the first slot-pole value and the second slot-pole value.

10. The steering apparatus according to claim 9, wherein the number of the first poles is 6, the number of the first slots is 9, the number of the second poles is 10, the number of the second slots is 12, and the least common multiple of the first slot-pole value and the second slot-pole value is 180.

11. The steering apparatus according to claim 9, wherein the number of the first poles is 8, the number of the first slots is 9, the number of the second poles is 10, the number of the second slots is 12, and the least common multiple of the first slot-pole value and the second slot-pole value is 360.

12. The steering apparatus according to claim 7, further comprising a magnetic insulator disposed between the inner rotor and the outer rotor.

13. The steering apparatus according to claim 7, further comprising a controller controlling an operation of the steering feedback motor,
wherein, in a case where an abnormality is detected in one of the inner stator and the outer stator, the controller applies a current only to the remaining stator that is in a normal state.

14. A steering feedback actuator apparatus that is a steering feedback actuator (SFA) apparatus configuring a steer-by-wire steering apparatus and operates separately from a road wheel actuator (RWA), the steering feedback actuator apparatus comprising:
a steering column connected to a steering wheel; and
a steering feedback motor that is connected to the steering column and is used for providing a steering feedback torque for the steering wheel,
wherein the steering feedback motor includes a motor shaft that is axially connected to the steering column, a dual rotor including an inner rotor and an outer rotor connected to the motor shaft, and a dual stator including an inner stator arranged on an inner side of the inner rotor and an outer stator arranged on an outer side of the outer rotor.

15. The steering feedback actuator apparatus according to claim 14, wherein a first slot-pole value defined as a least common multiple of the number of first poles of the inner rotor and the number of first slots of the inner stator and a second slot-pole value defined as a least common multiple of the number of second poles of the outer rotor and the number of second slots of the outer stator are different from each other.

16. The steering feedback actuator apparatus according to claim 15, wherein an order of a cogging torque of the steering feedback motor for the vehicle is determined in accordance with a least common multiple of the first slot-pole value and the second slot-pole value.

17. The steering feedback actuator apparatus according to claim 16, wherein the number of the first poles is 6, the number of the first slots is 9, the number of the second poles is 10, the number of the second slots is 12, and the least common multiple of the first slot-pole value and the second slot-pole value is 180.

18. The steering feedback actuator apparatus according to claim 16, the number of the first poles is 8, the number of the first slots is 9, the number of the second poles is 10, the number of the second slots is 12, and the least common multiple of the first slot-pole value and the second slot-pole value is 360.

19. The steering feedback actuator apparatus according to claim 14, further comprising a magnetic insulator disposed between the inner rotor and the outer rotor.

20. The steering feedback actuator apparatus according to claim 14, further comprising a controller controlling an operation of the steering feedback motor,
wherein, in a case where an abnormality is detected in one of the inner stator and the outer stator, the controller applies a current only to the remaining stator that is in a normal state.
